(19) United States
(12) Patent Application Publication
(10) Pub. No.: US 2012/0199213 A1
(43) Pub. Date: Aug. 9, 2012

(54) Snap-In Quick Removal Pop-Up Drain Stopper

(76) Inventor: Richard Martin Reavis, Tucson, AZ (US)

(21) Appl. No.: 13/024,317

(22) Filed: Feb. 9, 2011

(51) Int. Cl. F16K 5/00

(52) U.S. Cl. 137/15.24

(57) ABSTRACT

The present invention improves upon a pop-up drain stopper of the type which is controlled by a horizontal pivot rod as is typically used in bathroom sinks, through incorporation of a new snap-in method for attachment of the stopper to the pivot rod whereby the stopper can be easily and quickly removed and reinstalled as is normally required to clear a clogged drain. The present invention is installed by inserting the stopper into the drain opening with the bottom connecting bracket channel opening positioned over the pivot rod and applying downward pressure forcing the pivot rod to pass through the narrow channel and snap into the connecting bracket journal. Transversely, by pulling upward, the stopper is disengaged from the pivot rod and can be quickly removed from the drain opening allowing for convenient and efficient extraction of drain clogs without the necessity of disassembling the mechanical components located under the sink as is required to remove the typical pop-up stopper.

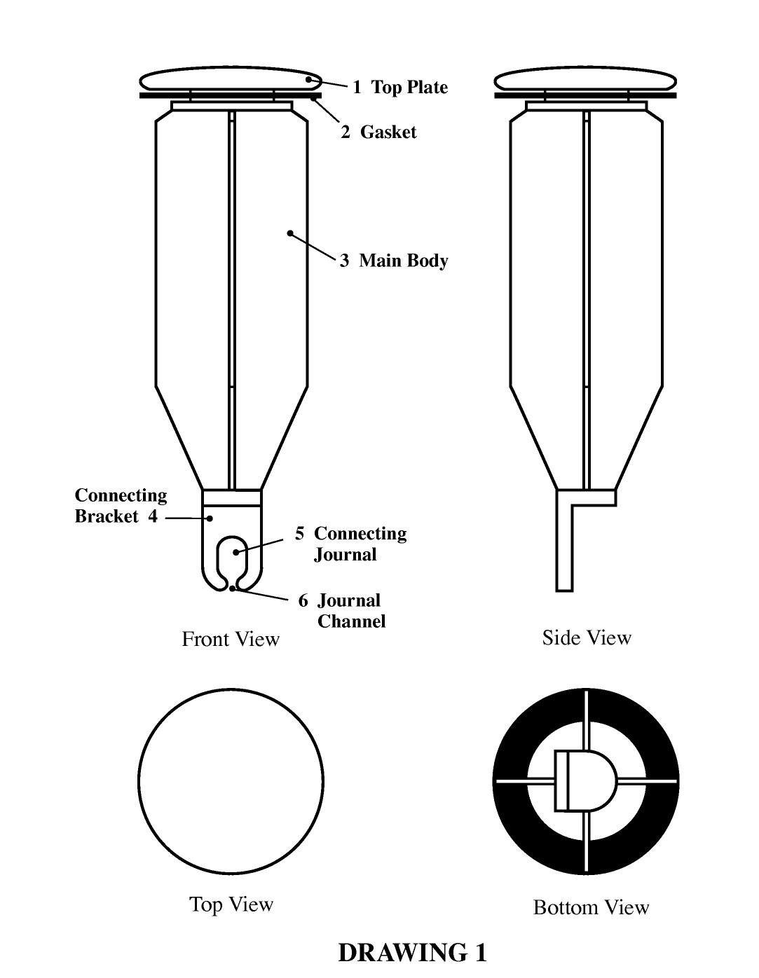

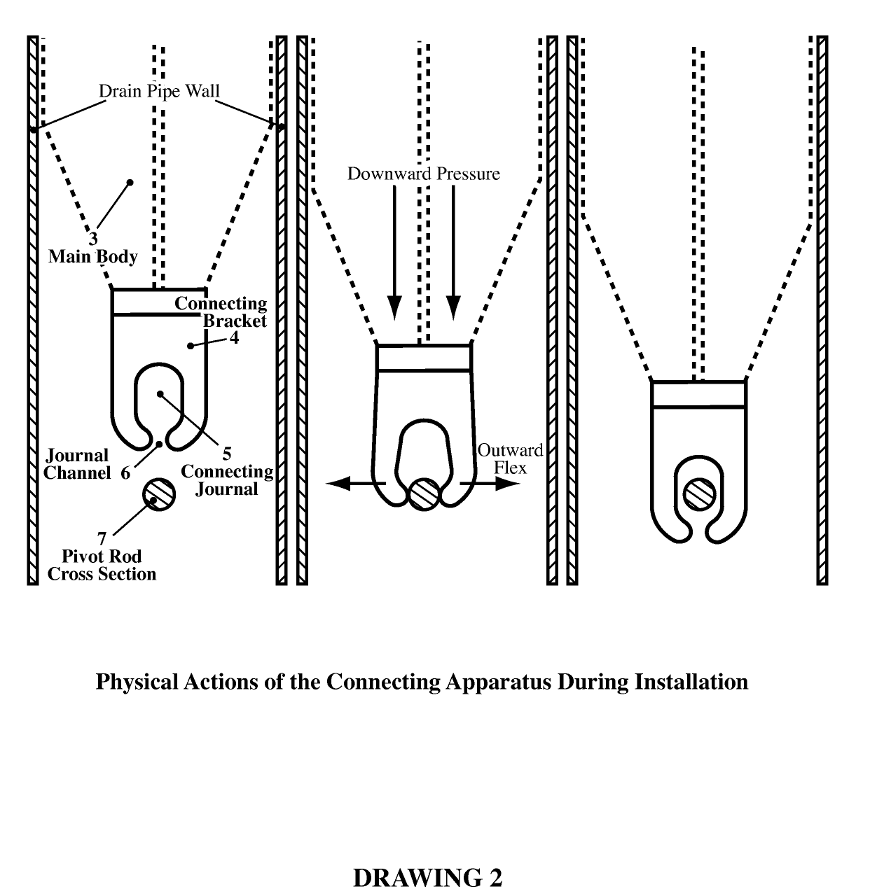

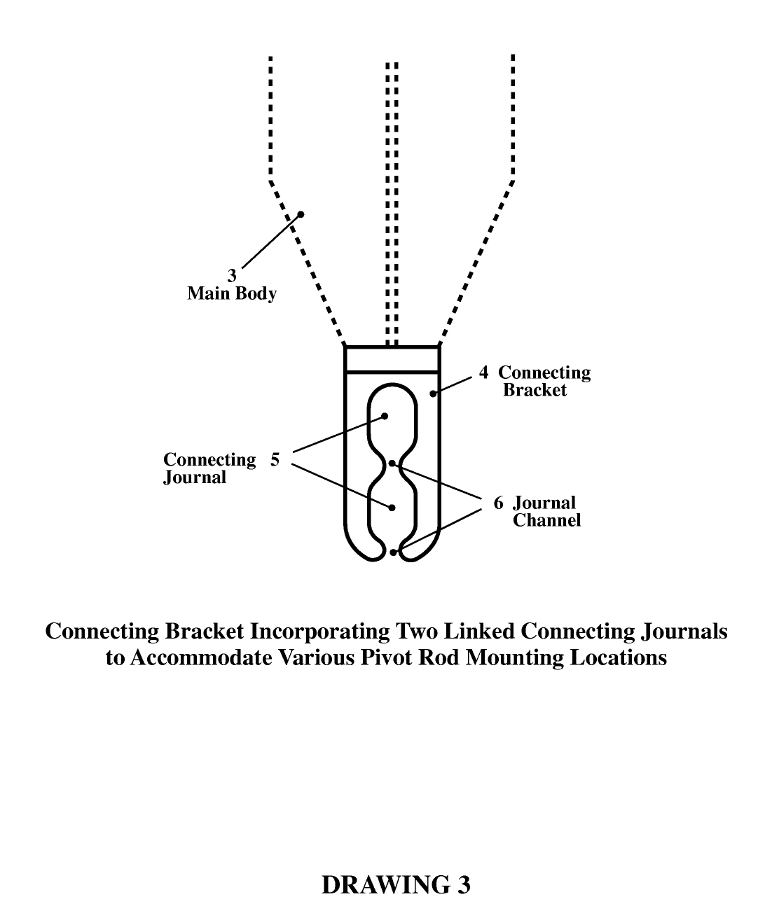

### BACKGROUND OF THE INVENTION

The present invention is directed to the device of pop-up bathroom sink drain stopper, the up and down function of which is controlled by a horizontal pivot rod mounted through the drain pipe wall and extending through a hole penetrating the lower end of the stopper body thereby securing the stopper in place within the drain pipe. The specific problem in the prior art to which the present invention is drawn, is the necessity of the under the sink disassembly of the mechanical apparatus and removal of the pivot rod in order to extract the current typical stopper from the drain as is required to properly remove a clog.

### SUMMARY OF THE INVENTION

The present invention solves the specific problem of the prior art through an improvement of the stopper body apparatus and method by which the stopper is connected to the pivot rod thus providing a quick and convenient means of removal and reinstallation. Positioned at the bottom of the stopper body, the present invention employs a vertical connecting bracket with a pivot rod connecting journal having an opening at the bottom center point of its perimeter which extends vertically beyond the exterior bottom edge of the connecting bracket thereby creating a channel through which the pivot rod enters the journal. The channel is of a diameter slightly less than that of the pivot rod causing a restriction which prevents the rod from disengaging during normal use. The interior and exterior edges of the channel opening are radiused to assist in guidance and passage of the pivot rod into and out of the journal. Installation is accomplished by inserting the stopper into the drain opening with the journal channel opening positioned over the pivot rod and applying downward pressure to the top of the stopper causing the pivot rod to forcefully pass through the channel restriction and enter the journal thereby connecting the stopper to the pivot rod. Removal is achieved by pulling upward on the stopper causing the pivot rod to exit the journal thus disengaging the stopper and permitting its extraction from the drain opening allowing unobstructed access for drain clog removal. A clogged bathroom sink drain is something most consumers experience several times a year. The involved process of removing the current typical pop-up stopper to effectively address a clog is inconvenient at least, if not beyond the capability of the average consumer. The present invention provides an easy, simple and convenient solution to this common problem.

### DESCRIPTION OF THE DRAWINGS

Drawing 1 depicts the front, side, top and bottom views of snap-in quick removal pop-up drain stopper embodying the principals of the present invention.

Drawing 2 demonstrates the physical actions of the present invention and its method and means of attachment to the pivot rod during installation.

Drawing 3 depicts a configuration of the present invention employing multiple journals to accommodate varying pivot rod locations.

### DETAILED DESCRIPTION OF THE INVENTION

When inserted into the opening of a drain of the type employing a pivot rod to control the up and down motion of the stopper, as is commonly found in a bathroom sink, and positioning the invention with the opening of the Connecting Bracket (4) vertically above the pivot rod, downward pressure applied to the Top Plate (1) causes the pivot rod to forcefully pass through the Journal Channel (6) and enter the Connecting Journal (5) thereby securing the stopper to the pivot rod. The Main Body (3) consists of lateral fins radiating from a central vertical axis and are of a radius of such that their combined diameter is slightly less than that of the inside diameter of the drain pipe and serve to center the device within the drain. A Gasket (2) positioned below the Top Plate prevents water leakage when the device is closed.

The present invention should be constructed of plastic or a similar material of sufficient flexibility, as illustrated in DRAWING 2, to allow the passage of the Journal Channel (6) to outwardly flex and accommodate the greater diameter of the Pivot Rod (7) as it is forced into the Connecting Journal (5) during the installation process. The material of construction must also possess the physical properties necessary for the Journal Channel to return to and maintain its original shape and configuration with appropriate rigidity to prevent the Pivot Rod from exiting the Connecting Journal under normal operating conditions unless sufficient upward force is applied to the device as is required for its removal.

As demonstrated in DRAWING 3, the Connecting Bracket (4) could be configured with additional Connecting Journal(s) (5) positioned in vertical alignment and in spatial contact through vertically aligned Journal Channel(s) (6) allowing the invention to accommodate various pivot rod locations.

What is claimed as being new and desired for patent protection is:

1. A Method providing for the snap-in installation and quick removal of a pop-up drain stopper of the type controlled by a pivot rod as is typically found in bathroom sinks, said device comprising:
a circular top plate of a diameter slightly greater than the drain opening for which it is intended;
a vertical main body consisting of laterally radiating fins of a combined diameter slightly less than that of the interior diameter of the drain pipe in which the device is inserted and centrally connected to the bottom surface of the top plate;
a vertical connecting bracket positioned at and connected to the bottom of the main body penetrated by a connecting journal of ample size and dimension to accommodate the diameter of the pivot rod and positioned along the vertical axis of the device;
a vertical journal channel originating beyond the bottom physical perimeter of the connecting bracket and in center alignment with and extending beyond the physical perimeter of the connecting journal and of a diameter slightly less than that of the pivot rod creating a restrictive spatial passage through which the pivot rod can travel and enter the connecting journal;
snap-in installation through positioning the journal channel opening over the pivot rod and applying downward force to the top plate forcing the pivot rod to pass through the journal channel and enter the connecting journal; quick removal by applying upward force to the top plate forcing the pivot rod to exit the connecting journal and pass through the journal channel disengaging the device from the pivot rod.
